(19) United States
(12) Patent Application Publication
(10) Pub. No.: US 2005/0048361 A1
(43) Pub. Date: Mar. 3, 2005

(54) Stacked type lithium ion secondary batteries

(76) Inventors: Chaunfu Wang, Shenzhen (CN); WeiPing Liu, Shenzhen (CN); Hong Xiao, Shenzhen (CN); Yuchen He, Shenzhen (CN)

Correspondence Address: EMIL CHANG;LAW OFFICES OF EMIL CHANG, 874 JASMINE DRIVE, SUNNYDALE, CA, 94086, US

(21) Appl. No.: 10/932,362

(22) Filed: Aug. 31, 2004

(30) Foreign Application Priority Data
Sep. 1, 2003 (CN) 03 1 40377.8
Sep. 1, 2003 (CN) 03140376.X
Oct. 28, 2003 (CN) 2003101119664

(51) Int. Cl. H01M 2/18; H01M 2/04; H01M 4/02; H01M 4/66; H01M 4/58; H01M 2/08; H01M 2/02

(52) U.S. Cl. 429/130; 429/176; 429/175; 429/211; 429/61; 429/231.8; 429/245; 429/185

(57) ABSTRACT

A type of stacked lithium ion secondary battery is disclosed. Therein, the positive electrode is formed by smearing an active material on the surface of an aluminum foil body, where said active material includes lithium with attachable and detachable lithium ions and compound oxide(s) of transition metals; and a strip extending from said aluminum foil body is used as the conductor of the positive electrode. The negative electrode is formed by smearing an active material on the surface of a copper foil body, where said active material includes carbon material capable of attaching and detaching lithium ions; and a strip extending from said copper foil body is used as the conductor of the negative electrode. The positive and negative electrodes in plate form are arranged and stacked on the two sides of the separator forming said electrode core. The stacked lithium ion secondary battery can effectively use the internal space of the battery shell, increasing the capacity density and decreasing the battery's internal resistance; thereby improving the large current discharge characteristic of the lithium ion secondary battery.

### CROSS REFERENCE

This application claims priority to a Chinese patent application entitled “Cylindrical Lithium Ion Secondary Batteries” filed on Sep. 1, 2003, having a Chinese Patent Application No. 03140377.8; this Chinese application is incorporated herein by reference. This application further claims priority to a Chinese patent application entitled “Stacked Lithium Ion Secondary Batteries” filed on Sep. 1, 2003, having a Chinese Patent Application No. 03140376.X; this Chinese application is incorporated herein by reference. This application further claims priority to a Chinese patent application entitled “Lithium Ion Secondary Batteries” filed on Oct. 28, 2003, having a Chinese Patent Application No. 2003101119664; this Chinese application is incorporated herein by reference.

This application is a continuation-in-part of and claims priority from a U.S. application entitled “Cylindrical Lithium Ion Battery” filed on Aug. 26, 2004 having an application Ser. No. ______ yet to be received ______.

### FIELD OF INVENTION

The present invention relates to a type of lithium ion secondary battery, and, in particular relating to a stacked type lithium ion secondary battery having good large current discharge characteristic and high efficiency in space usage.

### BACKGROUND

Along with the rapid development of science and technology, electronic instruments and the miniaturization of electronic equipment placing higher and higher demand on the characteristics of secondary batteries, from the combined characteristics, lithium ion secondary batteries have the highest development and application potential and very good characteristics as secondary batteries. A widely used battery type in the market place is a cylindrical lithium ion secondary battery made from belt-shaped positive electrode, negative electrode, and separator all rolled into a cylindrically-shaped core and encased in a battery shell. Or, a belt-shaped positive electrode, negative electrode, and separator all rolled into a cylindrically-shaped core and flattened and inserted in to a rectangular shaped battery shell forming a rectangular-shaped lithium ion secondary battery. However, this type of structure for a rectangular lithium ion secondary battery has the problem of low efficiency in space usage.

Otherwise, when compared to other secondary batteries, the internal resistance of lithium ion batteries is higher, thus the voltage rapidly decreases during high discharge; the discharge time greatly shortens, and the battery capacity highly decreases. As commonly known, the low conductivity of the electrodes is one of the primary reasons the internal resistance of a lithium ion secondary battery may be high. Currently, most of the commercial lithium ion secondary battery use a single or multiple conductors (also called current collectors) as the method for current conduction; but this method of current charge and discharge is limited to a few welding points, where conductibility is low and the current is unevenly distributed in the charging and discharging process.

Thus, the important questions in improving the characteristics of lithium ion batteries are how to effectively use the internal space of the battery shell, how to reach high battery capacity density, how to decrease the battery's internal resistance, and how to improve the large current discharge characteristic of the lithium ion secondary battery.

### SUMMARY OF THE INVENTION

An object of the present invention is to provide a stacked type lithium ion secondary battery that efficiently utilizes the internal space of a battery.

Another object of the present invention is to provide a stacked type lithium ion secondary battery having a large capacity, low internal resistance, and good large current characteristics.

Briefly, A lithium ion secondary battery is disclosed, comprising one or more rectangular shaped positive electrodes each having a first length and a first width; one or more rectangular shaped negative electrodes each having a second length and a second width, wherein said first length equals said second length and said first width equals said second width; a belt-shaped separator having a third length and a third width, wherein said third width equals said first length, wherein said belt-shaped separator folded in a z-form having a plurality of folds and having alternating positive electrodes and negative electrodes inserted in said folds to form an electrode group; and a rectangular shaped battery shell having an internal space having a fourth length, a fourth width, and a fourth thickness, wherein said fourth length equals said first length and said fourth width equals said first width, and wherein said electrode group inserted in said battery shell.

An advantages of the stacked type lithium ion secondary battery of the present invention include:
(1) efficiently using the internal space of a battery shell, thereby increasing the battery capacity; and
(2) lowering the internal resistance of the battery, thereby improving the large current discharge characteristics of the lithium ion battery.

### DESCRIPTION OF THE FIGURES

FIG. 1 is a cross-sectional view of the stacked type lithium ion secondary battery of the present invention.

FIG. 2 is structural view of the positive electrode of the stacked type lithium ion secondary battery of the present invention.

FIG. 3 is an illustration of the electrode core of the stacked type lithium ion secondary battery of the present invention formed by positive and negative electrodes.

FIG. 4 is a graphical illustration of the discharge rate of the present embodiment and the comparison embodiment of the stacked type lithium ion battery of the present invention.

### DETAILED DESCRIPTION OF THE PREFERRED EMBODIMENTS

In the presently preferred embodiments of the present invention, it is disclosed: a stacked type lithium ion secondary battery, including positive electrode, separator, negative electrode and non-aqueous electrolyte, encased in a battery shell with its opening sealed by a battery cover, therein:
the positive electrode is formed by smearing an active material on the surface of an aluminum foil body, where said active material includes lithium with attachable and detachable lithium ions and compound oxide(s) of transition metals; and having a strip extending from said aluminum foil body used as the conductor of the positive electrode;
the negative electrode is formed by smearing an active material on the surface of a copper foil body, where said active material includes carbon material capable of attaching and detaching lithium ions; and having a strip extending from said copper foil body used as the conductor of the negative electrode; and
the positive and negative electrodes in plate form are arranged and stacked on the two sides of the separator forming said electrode core.

The above described technical method is further improved where:
the described separator is a belt-shaped membrane, folding in a z-form, the positive electrodes and negative electrodes are alternately placed in the folds of said membrane thereby being mutually non-conducting;
the described conductors of the positive and negative electrodes are separately stacked and spot-welded to the positive terminal and the negative terminal of said battery cover; or connecting one end of the described conductors of the positive and negative electrodes to a metal plate, and through said metal plate connecting to the positive terminal and the negative terminal of said battery cover; and
the two outer-most plates of the described stacked core having active material only on one of its sides and that side facing inward.

In the preferred embodiments of the present invention, positive and negative electrodes are in plate form, arranged alternately on the two sides of the belt-shaped separator, where the separator is folded in a z-shape forming the battery core. The above described battery core is placed into a battery shell with its opening sealed by a battery cover to complete the stacked type lithium ion secondary battery. Therein, the preferred size of the positive and negative electrodes is the same as the size of the positive electrode and the size of the negative electrode. With both the thickness of the electrodes being the same as the battery shell, using the structure of the battery core of the preferred embodiments of the present invention, the overall dimensions of the positive electrode can be larger than the traditional rolled type positive electrodes. Therefore, the space usage of the stacked type lithium ion secondary battery of the preferred embodiments of the present invention is higher than that of the traditional rolled-type lithium ion secondary battery, thereby having higher energy density.

The conductors of the positive and negative electrodes are strips extending from the foil body of the positive and negative electrodes. The positions of the conductors of the positive and negative electrodes are alternately arranged, and connected through the use of weld spots to the positive and negative terminals of the battery cover. Alternately, one end of the conductors of the positive and negative electrodes can be connected to a metal plate, and through said metal plate connected to the positive and negative terminals of said battery cover, thereby lowering battery internal resistance and improving the characteristics of the large current discharge of the lithium ion secondary battery.

In yet another embodiment, the conductor of each electrode is a strip that melts in a short circuit condition in order to limit the damage from short-circuiting to the particular electrode where it occurs. The strip can be welded on the foil body of the electrodes or it can be an extension from the foil body if the foil body material is suitable for such application or the strip can be cut for such application. In yet still another embodiment, the belt-shaped separator on one end extends and wraps around the entire stacked electrode group to insulate it from the battery shell and/or each other.

Present Embodiments

The making of the positive electrode of the stacked type lithium ion battery of the preferred embodiments of the present invention: mixing 100 units by weight of LiCoO2 powder, 7 units by weight of crystalline-shaped carbon as conducting paste, and 7 units by weight of PVDF as sticky paste; diluting in sufficient solution of N-methyl pyrrolidone to form a paste; smearing said compound paste on both sides of a 20 μm aluminum foil; removing the positive electrode paste from the extension portion of the aluminum foil body to obtain the conductor 5 of the positive electrode 1; and though drying and pressing to get a positive electrode 1 having the dimension of 44×31×0.12 mm, as illustrated by FIG. 2.

The making of the negative electrode of the stacked type lithium ion battery of the preferred embodiments of the present invention: mixing 100 units by weight of man-made carbon powder, 10 units by weight of PTFE as sticky paste; diluting in sufficient amount of ion-free solution to form a paste; evenly smearing said compound paste on both sides of a 10 μm copper foil; removing the negative electrode paste from the extension portion of the copper foil body to obtain the conductor 5 of the negative electrode 2; and though drying and pressing to form a negative electrode 2 having the dimension of 44×31×0.12 mm, where the external features are the same as the positive electrode.

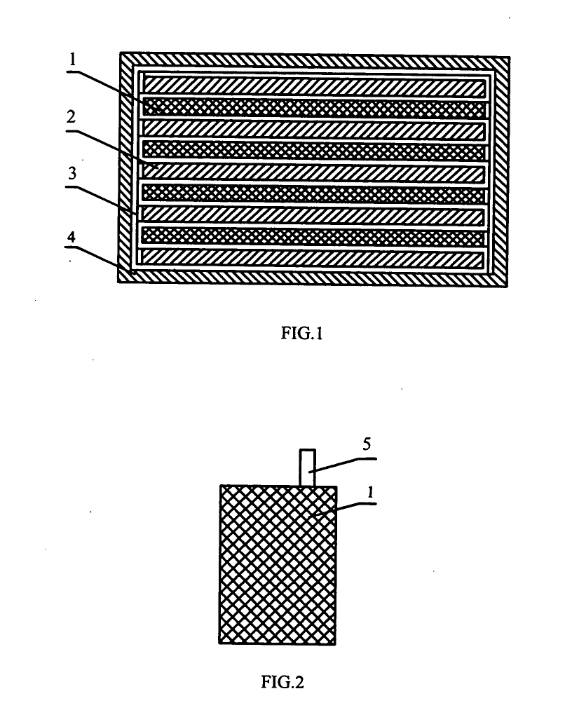

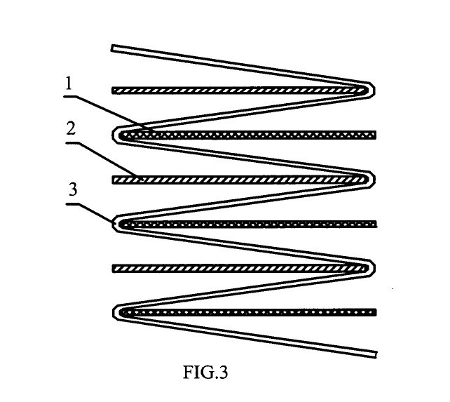

The assembly process of the stacked lithium ion secondary battery of the preferred embodiments of the present invention: said above described positive electrodes and said negative electrodes are arranged and stacked on the two sides of a belt-shaped separator 3 to form said electrode core. As shown by FIG. 3, an illustration of the battery core formed with positive and negative electrodes and the separator, therein the dimension of the separator is 47×720×0.016 mm, and the separator in z-form separating the positive and negative electrodes. The above described battery core is placed into a battery shell 4, and LiPF6 organic electrolyte is added, with the opening of the battery shell sealed by a battery cover to form said stacked type lithium ion secondary battery. FIG. 1 illustrates a cross sectional view of the structure of the stacked type lithium ion secondary battery.

Comparison Embodiment

The making of the positive electrode: mixing 100 units by weight of LiCoO2 powder, 7 units by weight of crystalline-shaped carbon as conducting paste, and 7 units by weight of PVDF as sticky paste; diluting in sufficient solution of N-methyl pyrrolidone to form a paste; evenly smearing said compound paste on both sides of a 20 μm aluminum foil; using available technology to dry and press; using traditional spot-welding structure to ultra-sonicly weld a 0.1 mm thick aluminum strip to the foil body of the positive electrode to form the conductor of the positive electrode; and thereby obtaining a positive electrode having the dimension of 43.5×315 mm.

The making of the negative electrode: mixing 100 units by weight of man-made carbon powder, 10 units by weight of PTFE as sticky paste; diluting in sufficient amount of ion-free solution to form a paste; evenly smearing said compound paste on both sides of a 10 μm copper foil; using available technology to dry and press; using traditional spot-welding structure to (resistance-type) weld a 0.15 mm thick nickel strip to the foil body of the negative electrode to form the conductor of the negative electrode; and thereby obtaining a negative electrode having the dimension of 44.5×280 mm.

Assembly process: Using traditional assembly method to stack in order positive electrode, separator, negative electrode and roll and press flat to form the battery core; inserting in said battery shell, using LiPF6 organic electrolyte, the opening sealed with a battery cover; and obtaining traditional rectangular lithium ion secondary battery.

Functional Test

Conducting functional tests of the present embodiment and the comparison embodiment by the following steps:
(1) At 20° C., using 1C constant voltage charge, having the upper voltage at 4.2V, let it stand for 5 minutes;
(2) Using 0.5C constant discharge rate to 3.0V; standing for 5 minutes; and obtaining the 0.5C discharge graph for the present embodiments and the comparison embodiment;
(3) Repeat step (1), using 1.0C constant discharge rate to 3.0V; standing for 5 minutes; and obtaining the 1.0C discharge graph for the present embodiments and the comparison embodiment;
(4) Repeat step (1), using 2C constant discharge rate to 3.0V; standing for 5 minutes; and obtaining the 2C discharge graph for the present embodiments and the comparison embodiment; and
(5) Repeat step (1), using 3C constant discharge rate to 3.0V; standing for 5 minutes; and obtaining the 3C discharge graph for the present embodiments and the comparison embodiment.

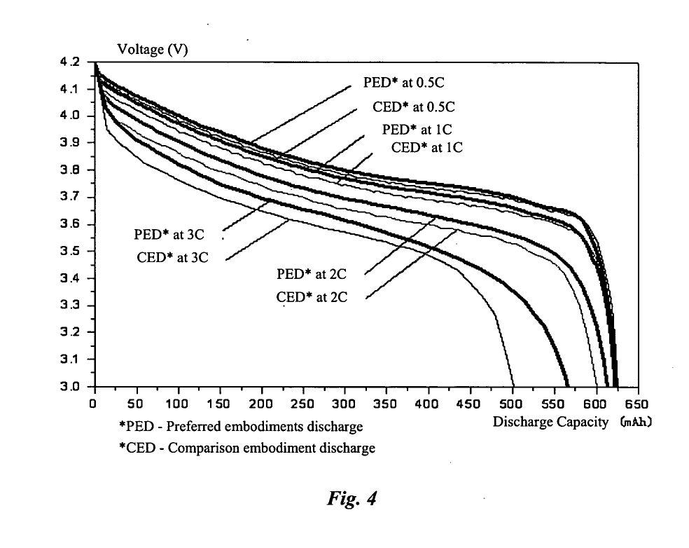

In FIG. 4, with the present embodiments and the comparison embodiment, the 0.5C and 1C discharge plots are fairly close. However there are apparent differences between the 2C and 3C discharge plots. In the 2C and 3C discharge plots, at the same voltage, the discharge capacity is clearly higher than the comparison embodiment.

With large current discharge, C_{3C}/C_{0.5C}: comparing the discharge capacity in using 3C current discharge from 4.2V to 3.0V and in using 0.5C current discharge from 4.2V to 3.0V.

With-large current discharge, C_{2C}/C_{0.5C}: comparing the discharge capacity in using 2C current discharge from 4.2V to 3.0V and in using 0.5C current discharge from 4.2V to 3.0V.

With large current discharge, C_{1C}/C_{0.5C}: comparing the discharge capacity in using 1C current discharge from 4.2V to 3.0V and in using 0.5C current discharge from 4.2V to 3.0V.

In using different current discharge rates the following results are obtained and listed in the following table:

| | C_{1C}/C_{0.5C} | C_{2C}/C_{0.5C} | C_{3C}/C_{0.5C} |
|---|---|---|---|
| | (%) | (%) | (%) |
| Present | 99.7 | 97.6 | 90.2 |
| Embodiment | | | |
| Comparison | 99.5 | 94.4 | 74.0 |
| Embodiment | | | |

It can be seen from the table, the large current characteristic is better with the battery of the preferred embodiments of the present invention than the battery of traditional structure.

While the present invention has been described with reference to certain preferred embodiments, it is to be understood that the present invention is not to be limited to such specific embodiments. Rather, it is the inventor's contention that the invention be understood and construed in its broadest meaning as reflected by the following claims. Thus, these claims are to be understood as incorporating and not only the preferred embodiment described herein but all those other and further alterations and modifications as would be apparent to those of ordinary skilled in the art.

1. A lithium ion secondary battery, comprising:
one or more rectangular shaped positive electrodes each having a first length and a first width;
one or more rectangular shaped negative electrodes each having a second length and a second width, wherein said first length equals said second length and said first width equals said second width;
a belt-shaped separator having a third length and a third width, wherein said third width equals said first length, wherein said belt-shaped separator folded in a z-form creating a plurality of folds and having alternating positive electrodes and negative electrodes stacked in said folds to form an electrode group; and
a rectangular shaped battery shell having an internal space having a fourth length, a fourth width, and a fourth thickness, wherein said fourth length equals said first length and said fourth width equals said first width, and wherein said electrode group is inserted in said battery shell.

2. A lithium ion battery as recited in claim 1 wherein further comprising a battery cover sealing said battery shell.

3. A lithium ion battery as recited in claim 1 wherein said separator at one end length-wise wraps around said electrode group.

4. A lithium ion battery as recited in claim 1 wherein each of said positive electrodes and negative electrodes has a foil body and extending therefrom a strip serving as the conductor of the respective electrode.

5. A lithium ion battery as recited in claim 4 wherein each of said electrode's conductor breaks when there is a short-circuit condition with respect to that electrode.

6. A lithium ion battery as recited in claim 2 wherein each of said positive electrodes and negative electrodes has a foil body and extending therefrom a strip serving as the conductor of the respective electrode.

7. A lithium ion battery as recited in claim 6 wherein each of said electrode's conductors breaks when there is a short-circuit condition with respect to that electrode.

8. A lithium ion battery as recited in claim 6 wherein on said battery cover or said battery shell there are a negative terminal and a positive terminal and said respective conductors connect to said negative terminal or said positive terminal.

9. A lithium ion battery as recited in claim 1 further comprising electrolyte injected in said battery shell.

10. A lithium ion battery as recited in claim 1 wherein said positive electrode is formed by smearing an active material on the surface of an aluminum foil body, where said active material includes lithium with attachable and detachable lithium ions and compound oxide(s) of transition metals.

11. A lithium ion battery as recited in claim 1 wherein said negative electrode is formed by smearing an active material on the surface of a copper foil body, where said active material includes carbon material capable of attaching and detaching lithium ions.

12. A lithium ion secondary battery, comprising:
one or more rectangular shaped positive electrodes each having a first length and a first width and a conductor extending from each said positive electrode, wherein each of said positive electrode conductors breaking on a short-circuit condition;
one or more rectangular shaped negative electrodes each having a second length and a second width and a conductor extending from each said negative electrode, wherein said first length equals said second length and said first width equals said second width and wherein each of said negative electrode conductors breaking on a short-circuit condition;
a belt-shaped separator having a third length and a third width, wherein said third width equals said first length, wherein said belt-shaped separator folded in a z-form having a plurality of folds and having alternating positive electrodes and negative electrodes stacked in said folds to form an electrode group and wherein said separator on one end extending and wrapping around said electrode group;
a rectangular shaped battery shell having an internal space having a fourth length, a fourth width, and a fourth thickness, wherein said fourth length equals said first length and said fourth width equals said first width, and wherein said electrode group inserted in said battery shell;
electrolyte injected in said battery shell; and
a battery cover sealing said battery shell wherein the conductors connecting to said battery shell or said battery cover.

13. A lithium ion battery as recited in claim 12 wherein said positive electrode is formed by smearing an active material on the surface of an aluminum foil body, where said active material includes lithium with attachable and detachable lithium ions and compound oxide(s) of transition metals.

14. A lithium ion battery as recited in claim 12 wherein said negative electrode is formed by smearing an active material on the surface of a copper foil body, where said active material includes carbon material capable of attaching and detaching lithium ions.
